(19) United States
(12) Patent Application Publication
(10) Pub. No.: US 2014/0294905 A1
(43) Pub. Date: Oct. 2, 2014

(54) ANTIMICROBIAL TEXTILES

(71) Applicant: BACTOGEN BIYOTEKNOLOJIK URUNLER SANAYI VE TICARET ANONIM SIRKETI, Istanbul (TR)

(72) Inventors: Fikrettin Sahin, Istanbul (TR); Selami Demirci, Istanbul (TR); Zeynep Ustaoglu, Istanbul (TR)

(21) Appl. No.: 14/358,532

(22) PCT Filed: Nov. 16, 2012
(86) PCT No.: PCT/IB2012/056488

§ 371 Date: May 15, 2014

(30) Foreign Application Priority Data
Nov. 16, 2011 (TR) 2011/11326

(51) Int. Cl. A01N 55/08

(52) U.S. Cl. CPC A01N 55/08
USPC 424/404; 424/660

(57) ABSTRACT

This invention is about textiles which are equipped with antifungal, anticandidal and antibacterial properties. The aim of the invention is to attain antimicrobial textiles which reduces the incidence of infections communicated or spread by textiles, reduces the loss of extra cost and energy to ensure hygiene and strengthens the hygienic condition of disposable textiles. Textiles can be equipped with antimicrobial properties in three ways: In the first method, sodium borate is dissolved in methanol and is then fixed to the fabric. In the second method, sodium borate is dissolved in water and is then sprayed onto the fabric. In the third method, sodium borate dissolved in water and mixed with textile dye and applied as a dye. Antimicrobial properties of sodium borate are tested on 38 bacterial species, 9 yeasts and 1 1 fungi isolates based on disc diffusion assay.

### TECHNICAL BACKGROUND

This invention is about textiles which are equipped with antifungal, anticandidal and antibacterial properties.

### PREVIOUS TECHNIQUES

Produced and used by mankind for thousands of years, natural textiles were generally made of plants and animals. However, in the last century, textiles produced from natural fibers were replaced by polymers such as nylon, viscose or rayon or a combination of them. In modern textile, natural fibers have been replaced by artificial fibers in order to attain new properties to the textile products. High elasticity or hydrophobic features can be given as examples of the targeted properties [1].

Natural products provide a suitable environment for microbial life since they are rich in nutrients. Microorganisms such as moulds, yeasts and bacteria generally adapt themselves to any environment and grow rapidly. A seasonal increase is seen in microbial flora due to the higher relative humidity in the internal surfaces of buildings which do not have good heat insulation. The growth of bacteria and fungus spores indoors not only causes allergic problems for people living in such areas but also is the source of infection for some clinically significant diseases. Moreover, some of the microorganisms growing under such conditions cause autoimmune disease despite being recognized as environmental organisms in normal conditions or cause various diseases in immunosuppressed individuals as opportunistic pathogens. Some studies show that hospitals are the root cause for the transmission of many infectious diseases [2]. According to the World Health Organization (WHO) data, approximately one out of every ten patient receiving inpatient treatment ends up having “hospital infection”. WHO indicates that this problem is more severe in developing countries than developed countries due to the lack of sufficient hygiene conditions and the lack of awareness on the importance of hospital infections and the significance of controlling infections in general [3].

Hospital-acquired infections include all diseases apart from the clinical manifestation causing the existing complaints the patient has. In a couple of hours after the admission of the patient, the natural flora of the patient starts to accept the bacterial flora in the environment. Most infection cases clinically manifest themselves 48 hours after admission to the hospital. This shows that the emerging infections are acquired at the hospital. Within hours after the admission of the patient, microorganisms start to grow and produce in the skin, respiratory tract and genitourinary system of the patient [4].

Hygiene has been an important criterion for cleanliness in developing societies. However, too hygienic an environment may cause undesired consequences. When the human body is exposed to a load of microorganisms, the defense system of the body is activated and it develops some immunity against the microorganisms. In parallel to the recently improving life standards, average life expectancy for human beings has also improved but individuals have become less resistant to microorganisms. This is due to the fact that microorganisms developed resistance against antibiotics and as a result the quantity of the active ingredients in antibiotics gradually increased [2]. Methicillin-resistant Sthaphylococcus aereus (MRSA) is an example of bacteria which acquired resistance to antibiotics. Resistant microorganisms cause severe pathogenic and epidemic cases specifically in hospitals. Such infections may be fungal as well as bacterial. Treatment costs for fungal infections are higher than the cost for the treatment of bacterial infections [5].

Research shows that 3 to 10% of the patients receiving inpatient treatment at hospitals are infected with pathogens having multiple antibiotic resistance, and therefore have a prolonged stay in hospital in addition to increased treatment costs. In some cases, even death occurs. In the US, more than 2 million people are affected by hospital infection cost an additional $5000-5500 [5].

The issue of hygiene in operating theatres is one of the causes of exposure to microbial contamination at hospitals. The primary pathogen causing surgical infections is Staphylococcus aereus (25.8%). The second most common pathogen is Enterobacteriaceae by 12.4%. These two are followed by Streptococcus spp. by 11.2%, Coagulase-Negative Staphylococcus by 10.1%, Enterococcus spp. by 7.9%, Pseudomonas aeruginosa by 6.7% and the increasingly and rapidly more infectious MRSA by 4.5%. The rate of patients infected with MRSA was 30% in 2000 whereas it had been 9% in 1995 [9]. Normal Staphylococcus aereus isolate is the most common pathogen causing skin and soft tissue infections, bone and joint infections, pneumonia and vascular infections. The number of Staphylococcus aereus infections has increased in the last 20 years and S. aereus has become the most common pathogen and a major problem in hospitals and health centres after the development of the MRSA [8].

In a study by John M. Boyce from 2009, it is reported that Methicillin-resistant Staphylococcus aereus (MRSA) and Vancomycin-resistant Enterococci (VRE) can survive at closed hospital areas for considerably long periods. These are contaminated on surfaces touched by visitors, nurses and caregivers and the colonization of microorganisms starts in the patient's room. Such pathogens may be communicated through frequently-touched surfaces or by medical consumables and chemicals used for patients or within the hospital during the daily routine of physicians, nurses and caregivers. Pathogens like MRSA, VRE and Clostridium difficile can survive up to 14 days on materials such as formica and 6 to 9 weeks on cotton surfaces [10].

Cross-contamination risk is considerably high during laundry process since the laundry is washed together in washing machines. Microorganisms are transferred from fabric to fabric during piling before washing and also during washing. They even stay within the machine and are transferred to the next piles washed [11]. This risk is much higher for clothes used and washed in populous places such as hotels, hospitals, dormitories, etc. It is only possible to speak of hygiene for clothes when textiles are cleaned and are devoid of dirt and stains and all factors and agents bearing a risk of contamination are removed. Since textiles used in hospitals have many pathogenic microorganisms on them, it is not sufficient to clean these products off stains but it is also necessary to remove the microbial flora [12].

Research on improving hygiene in clothes has developed with the increase in hygiene awareness. Scientists agree that the process of washing significantly decreases the load of microorganisms on the fabric. Despite the fact that so far there has been no publication establishing a link between microbial load and infections, data from Europe and elsewhere show that microbial load continues to exist on textiles after the process of washing [11]. Therefore, textiles such as under sheets, surgical drapes, drapers put under the surgical tools, aprons for patients, doctors and staff, masks and patient slippers are single-use products.

Today, disposable single-use products are generally sterilized and made available for use. However, sterilized products do not contain any microbial load only until they are unpacked. All unpacked products constitute a suitable environment for the growth of microorganisms as they have contact with air, surface or hands.

Japanese patent document numbered JP2011052338 mentions an antimicrobial textile and the methodology of attaining that specific textile. It is stated in the document that in order to attain this product it is necessary to use at least one zinc or copper ion first and then alkali metal oxide and alumina.

Textiles used so far present a suitable environment for the growth of microorganisms. In this invention hereby, it is found out that the application of sodium borate on textiles make them attain antimicrobial properties.

### BRIEF DESCRIPTION OF THE INVENTION

The aim of this invention is to attain textiles having antimicrobial properties.

Another aim of the invention is to attain textiles having antimicrobial properties which will reduce the incidence of infections communicated by textiles.

Another aim of the invention is to attain textiles having antimicrobial properties which will reduce the loss of extra cost and energy to ensure hygiene.

Another aim of the invention is to attain antimicrobial textiles strengthening the hygienic condition of disposable textiles.

### DETAILED DESCRIPTION OF THE INVENTION

Antimicrobial textiles attained in order to fulfill the aim of the invention are presented in the figures available in the appendix. These are as follows:

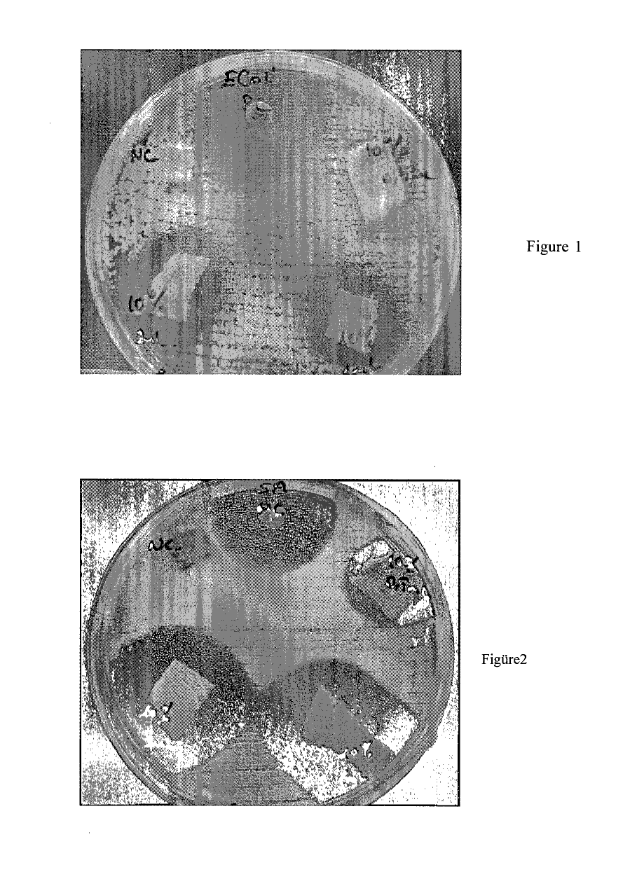

FIG. 1—Effect of textiles attained through spraying various amounts of 10% sodium borate solution with a pH set to 10 against Escherichia coli.

FIG. 2—Effect of textiles attained through spraying various amounts of 10% sodium borate solution with a pH set to 10 against Staphylococcus aureus.

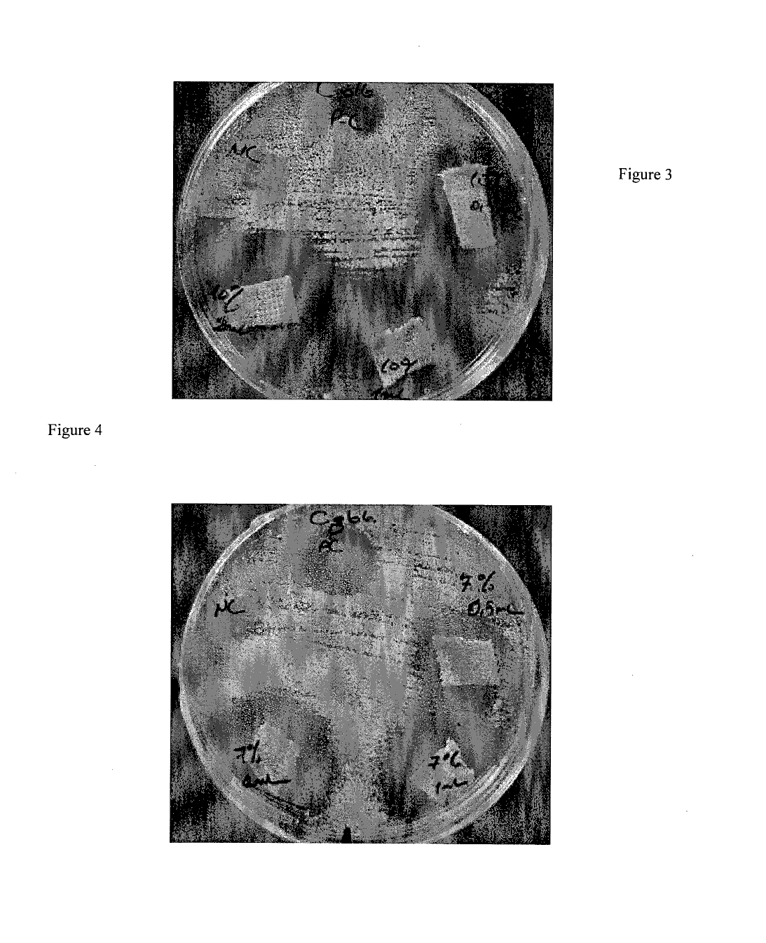

FIG. 3—Effect of textiles attained through spraying various amounts of 10% sodium borate solution with a pH set to 10 against Candida albicans.

FIG. 4—Effect of textiles attained through spraying various amounts of 7% sodium borate solution with a pH set to 10 against Candida glabrata.

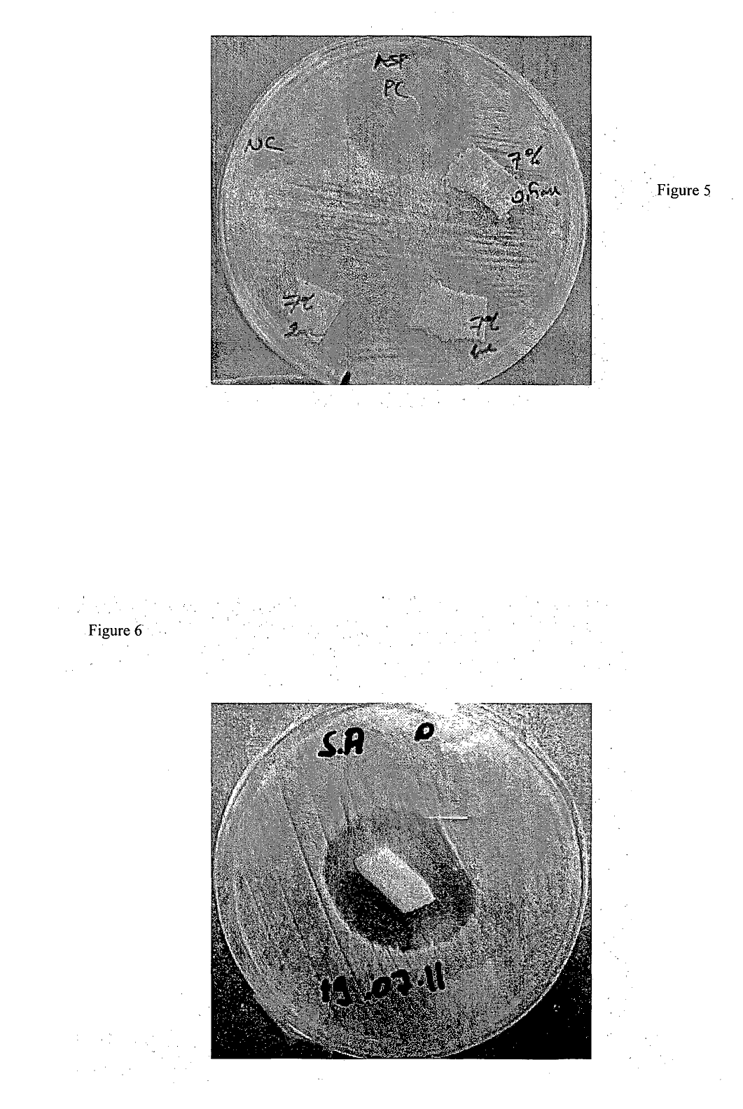

FIG. 5—Effect of textiles attained through spraying various amounts of 7% sodium borate solution with a pH set to 10 against Aspergillus niger.

FIG. 6—Effect of textiles attained through the fixation of 7% sodium borate-methanol solution against Staphylococcus aureus.

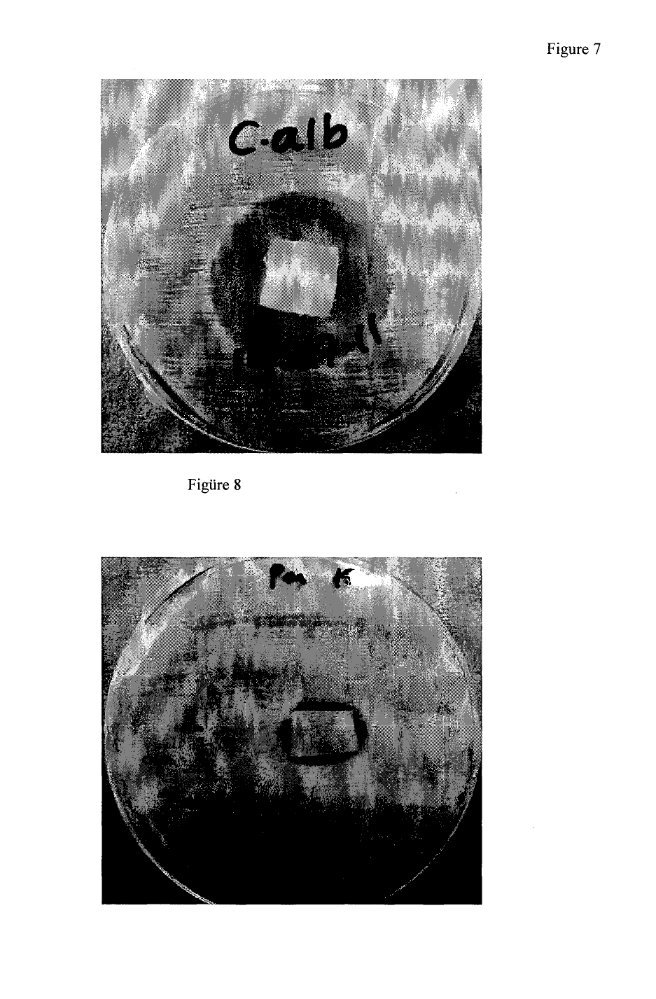

FIG. 7—Effect of textiles attained through the fixation of 10% sodium borate-methanol solution against Candida albicans.

FIG. 8—Effect of textiles attained through the fixation of 15% sodium borate-methanol solution against Penicillium expansum.

### DETAILED DESCRIPTION OF THE INVENTION

### Experimental Studies

Three different methods are used to attain the antimicrobial textiles that are the subject of this invention.

1^{st} Method: In this method, firstly, sodium borate is dissolved in methanol and is then fixed to the fabric. In this study, a solution is produced when sodium borate is dissolved in methanol within a mixture of 100 mL methanol +5-15 gr sodium borate and the ultrasonic bath set to 45° C. The textiles to be used are placed in this solution and then they are placed together into an oven set to 70° C. until the methanol within the solution evaporates. When the textile gets dry, sodium borate is fixed to the fabric. The base material for the textiles used can be any type of fabric used in the textile industry.

2nd Method: In another method applied for the purposes of this invention, sodium borate is dissolved in a high pH water (pH:10) and is then sprayed onto the fabric. 5-15% sodium borate solution is then homogenously sprayed onto the textile at a ratio of 0.2-0.8 L/m². After spraying, the textile is left aside in order for it to dry. The water solubility of sodium borate is around 2-3% in room temperature. However, when the pH of the water is increased to 10 with the addition of NaOH, water solubility of sodium borate also increases. This allows acquiring a 5-15% sodium borate solution in water in room temperature. As a result, textiles sprayed with sodium borate solution acquire antimicrobial properties.

3rd Method: In the last method for the purposes of this invention, sodium borate dissolved in water is mixed with textile dye before its application. The water solubility of sodium borate increases as its pH also increases. Therefore, the base of the water-based textile dye is prepared with a 5-15% sodium borate solution, the pH of which is set to 10. This mixture is then mixed with the textile dye at required ratios in order to acquire the desired colour.

The mixture is then applied onto the textile through spraying or fixation methods.

### Test Studies

### Modified Disc Diffusion Method

Standard NCCLS disc diffusion method [13] is modified for use in order to identify the antimicrobial activity of sodium borate on each of the tested microorganisms. A 100 μl solution containing 10⁸ cfu/ml bacteria, 10⁶ cfu/ml yeast and 10⁴ spores/ml mould is prepared from new cultures and is inoculated respectively onto triptonic soy agar (TSA), Sabouraud Dextrose Agar (SDA) and Potato Dextrose Agar (PDA) through the use of diffusion method. 20 μl of sterile water is dropped onto empty discs and the discs are then dipped into sodium borate in powder format. Discs dipped into sodium borate are then placed on planted petri dishes. As a negative control, blank discs onto which 20 μl of sterile water is dropped are used. As a positive control, Ofloxacin (10 μg/disc) and nystatin (30 μg/disc) are respectively used for bacteria and fungi.

Planted petri dishes on which modified disc diffusion method is applied are kept at 36±1° C. for 24 hours for bacteria, at 36±1° C. for 48 hours for yeasts and at 25±1° C. for 72 hours for moulds. Antimicrobial activity inhibition zone (a zone where no microorganisms grow) is measured and evaluated for microorganisms tested with modified disc diffusion method. All tests are repeated at least twice. The test results for the antimicrobial activity of the tested boron compounds are summarized at Table 1.

### Antimicrobial Tests

Sodium borate-added textiles prepared with three different techniques and the unprocessed textiles to which sodium borate is not added are placed on the petri dishes planted with microorganisms and their antimicrobial efficiency is tested.

Sodium borate-added textiles fixed with methanol, textiles sprayed with sodium borate dissolved in pH-enhanced water and textiles dyed with water-based textile dye the base of which is prepared by the addition of sodium borate are tested. As a negative control, any possible impact which inhibits the growing of microorganisms on textiles which are not processed is observed. As a positive control, Ofloxacin (10 μg/disc) and nystatin (30 μg/disc) are respectively used for bacteria and fungi. Planted petri dishes are kept at 37° C. for 24 hours for bacteria, at 37° C. for 48 hours for yeasts and at room temperature for 72 hours for moulds. Tested antimicrobial activity is evaluated upon the measuring of the inhibition zone of the microorganisms handled. All tests are repeated at least twice.

Experiments are done on some fungi and bacteria among the microorganisms. The types of bacteria experimented with are Acinetobacter baumannii, Acinetobacter calcoaceticus, Acinetobacter genomospecies, Actinomadura cremea, Bacillus coagulans, Bacillus megaterium, Bacillus subtilis, Brevundimonas vesicularis, Burkolderia glumea, Cellulosimicrobium cellulans, Chryseobacterium balustinus, Chryseobacterium meningosepticum, Duganella zoogloeoides, Enterococcus faecium, Escherichia coli, Gordonia rubropentinctuc, Gordonia sputi, Hydrogenophaga pseudoflava, Nocardia brasiliensis, Nocardia globerula, Nocardia transvalensis, Pantoea stewartii ss stewartii, Pseudomonas aeruginos, Pseudomanas chlororaphis, Pseudomonas flourescens, Pseudomonas maculicola, Pseudomonas putida, Pseudoxanthomonas spp., Pediococcus acidilactici/parvulus, Providencian heimbachae, Rhodococcus rhodnii, Sphingomonas terrae, Corynebacterium spp., Sphingomonas sanguinis, Staphylococcus aureus, MRSA, Staphylococcus hominis hominis, Stenotrophomonas maltophlia and Xanthomonas spp.

The types of yeasts used in experiments are Candida albicans, Candida glabrata, Candida parapsilosis, Candida tropicalis, Filobasidiella neoformansve, Hyphopichia burtanii, Kluyveromyces marxianus, Pichia membranifaciens and Schwanniomyces occidentalis.

The types of fungi used in experiments are Aspergillus spp., Alternaria spp., Botrytis spp., Fusarium spp., Paecilomyces lilacinus, Penicillium charlesii, Penicillium expansum, Penicillium vinaceum, Pythium spp., Phytophthora spp. and Sclerotinia sclerotiorum.

### Experiment Results

### Results of Antimicrobial Tests

Inhibition zones against the tested microorganisms are observed around the sections of samples taken from textiles added with sodium borate which is prepared with three different methods in order to attain an antimicrobial textile that is the subject of this invention whereas no inhibition zones are observed around the sections of the textile samples in the control group (Table 2).

TABLE 1
Antimicrobial effect of sodium borate on the microorganisms tested

| | Sodium | Positive | Negative |
|---|---|---|---|
| | Borate | Control | Control |
| BACTERIA | | Ofloxacin | Distilled Water |
| Escherichia coli | + | + | − |
| Staphylococcus aureus | + | + | − |
| Pseudomonas aeruginosa | + | + | − |
| YEASTS | | Nystatin | Distilled Water |
| Candida albicans | + | + | − |
| Candida glabrata | + | + | − |
| | | Nystatin | Distilled Water |
| MOULDS | | (30 μg/disc) | (20 μl/disc) |
| Aspergillus niger | + | + | − |
| Fusarium oxysporum | + | + | − |
| Botrytis cinerea | + | + | − |
| Penicillium vinaceum | + | + | − |
| Penicillium expansum | + | + | − |

+ indicates that sodium borate has an antimicrobial effect.
− indicates that distilled water does not have an antimicrobial effect.

TABLE 2
Antimicrobial test results against selected bacteria, fungi and yeast isolates/strains on
textiles added and not added with sodium borate and prepared with three different methods
under in vitro conditions

| | Methods of Preparing | | | | | | |
|---|---|---|---|---|---|---|---|
| | Antimicrobial Textiles | | | | | | |
| | 1st Method* | | 2^{nd} Method | | 3rd Method | | |
| | Sodium | Sodium | Sodium | Sodium | Sodium | Sodium | |
| | Borate | Borate | Borate | Borate | Borate | Borate | |
| | Added | Not | Added | Not | Added | Not Added | Positive Control |
| BACTERIA | | | | | | | Ofloxacin |
| | | | | | | | (10 μg/disc) |
| Escherichia coli | + | − | + | − | + | − | + |
| Staphylococcus aureus | + | − | + | − | + | − | + |
| MRSA | + | − | + | − | + | − | + |
| Pseudomonas aeruginosa | + | − | + | − | + | − | + |
| | | | | | | | Nystatin |
| YEASTS | | | | | | | (30 μg/disc) |
| Candida albicans | + | − | + | − | + | − | + |
| Candida glabrata | + | − | + | − | + | − | + |
| | | | | | | | Nystatin |
| MOULDS | | | | | | | (30 μg/disc) |
| Aspergillus niger | + | − | + | − | + | − | + |
| Fusarium oxysporum | + | − | + | − | + | − | + |
| Botrytis cinerea | + | − | + | − | + | − | + |
| Penicillium vinaceum | + | − | + | − | + | − | + |
| Penicillium expansum | + | − | + | − | + | − | + |

*1st Method, 2nd Method and 3rd Method represent the methods of applying sodium borate on textiles as summarized above in the experimental studies section.
+ indicates that (antimicrobial) inhibition zones are observed around the textiles added with sodium borate (FIG. 1-8).

The textile which is the subject of this invention can be used for dialysis filters, band-aids, surgery clothing, masks, scrub hats and caps, catguts and surgical cloth in the medical sector, for clothing industry, for work clothes, for fusing and interlining, for underwear, for babies' garments requiring hygiene, for carpets, curtains, floor tiles, table clothes, bed covers and all other home textiles requiring hygiene.

In addition to these, it can be used in the construction sector for siding and insulation elements to prevent the growth of microorganisms and any possible decay they may cause.

### REFERENCES

1. Askew, Peter D., “Measuring activity in antimicrobial textiles”, Chemistry Today, vol 27, January-February 2009.

2. Johannes Oosterom, “The importance of hygiene in modern society”, International Biodeterioration & Biodegradation, Volume 41, Issues 3-4, Pages 185-189, 1998.
3. World Helth Organization, “Prevention of hospital-acquired infections”, 2002.
4. Quoc V Nguyen, “Hospital-Acquired Infections”, Journal of Hospital Infection, 2004.
5. W. H. Sheng, J. T. Wang, D. C. T. Lu, W. C. Chie, Y. C. Chen, S. C. Chang, “Comparative impact of hospital-acquired infections on medical costs, length of hospital stay and outcome between community hospitals and medical centres”, Journal of Hospital Infection, Volume 59, Issue 3, Pages 205-214, March 2005.
6. L. T. Curtis, “Prevention of hospital-acquired infections: review of non-pharmacological interventions”, Journal of Hospital Infection, 69(3):204-19, Epub, 2008 Jun. 2.
7. Weigelt J A, Lipsky B A, Tabak Y P, Derby K G, Kim M, Gupta V., “Surgical site infections: Causative pathogens and associated outcomes”, Am J Infect Control, 38(2):112-20, 2010 March.
8. Cheol-In Kang, Jae-Hoon Song, Doo Ryeon Chung et al., “Clinical impact of methicillin resistance on outcome of patients with Staphylococcus aureus infection: A stratified analysis according to underlying diseases and sites of infection in a large prospective cohort”, Journal of Infection, Volume 61, Issue 4, Pages 299-306, October 2010.
9. Carol A. Cantlon, Mary E. Stemper, William R. Schwan, Michael A. Hoffman, Salah S. Qutaishat, “Significant pathogens isolated from surgical site infections at a community hospital in the Midwest”, American Journal of Infection Control, Volume 34, Issue 8, Pages 526-529, October 2006.
10. John M. Boyce, “Environmental contamination makes an important contribution to hospital infection”, Journal of Hospital Infection, Volume 65, Supplement 2, Pages 50-54, June 2007.
11. Elaine L. Larson, “Home hygiene: A remerging issue for the new millennium”, American Journal of Infection Control, Volume 27, Issue 6, Pages S1-S3, 1999 December.
12. S. Fijan, S. Sostar-Turk, A. Cencic, “Implementing hygiene monitoring systems in hospital laundries in order to reduce microbial contamination of hospital textiles”, Journal of Hospital Infection, 61(1):30-8, 2005 September.

13. Lalitha, M. K. and T. N. Vellore, “Manual on antimicrobial susceptibility testing”, URL: http://wwvv.ijmm.org/documents/Antimicrobial. doc, 2005.

1. Antimicrobial textiles attained through the application of sodium borate on textiles.

2. Antimicrobial textiles such as those mentioned in claim 1 which are characterized by the solution of 5-15gr sodium borate in 100 mL methanol.

3. Antimicrobial textiles such as those mentioned in claim 2 which are characterized by the solution of sodium borate in methanol at 45° C.

4. Antimicrobial textiles such as those mentioned in claim 3 which are characterized by the evaporation of sodium borate-methanol solution applied to the textiles.

5. Antimicrobial textiles such as those mentioned in claim 4 which are characterized by the evaporation at 70° C. of the sodium borate-methanol solution applied to the textiles.

6. Antimicrobial textiles such as those mentioned in claim 1 which are characterized by the dissolution of sodium borate in water which has a pH of 10.

7. Antimicrobial textiles such as those mentioned in claim 6 which are characterized by the application of 5-15% sodium borate solution on textiles.

8. Antimicrobial textiles such as those mentioned in claim 7 which are characterized by the application of 5-15% sodium borate solution on textiles at a ratio of 0.2-0.8 L/m².

9. Antimicrobial textiles such as those mentioned in claim 1 which are characterized by the mixture of 5-15% sodium borate solution with textile dye.

10. Antimicrobial textiles such as those mentioned in Request 1 which are tested on bacterial species Acinetobacter baumannii, Acinetobacter calcoaceticus, Acinetobacter genomospecies, Actinomadura cremea, Bacillus coagulans, Bacillus megaterium, Bacillus subtilis, Brevundimonas vesicularis, Burkolderia glumea, Cellulosimicrobium cellulans, Chryseobacterium balustinus, Chryseobacterium meningosepticum, Duganella zoogloeoides, Enterococcus faecium, Escherichia coli, Gordonia rubropentinctuc, Gordonia sputi, Hydrogenophaga pseudoflava, Nocardia brasiliensis, Nocardia globerula, Nocardia transvalensis, Pantoea stewartii ss stewartii, Pseudomonas aeruginos, Pseudomanas chlororaphis, Pseudomonas flourescens, Pseudomonas maculicola, Pseudomonas putida, Pseudoxanthomonas spp., Pediococcus acidilactici/parvulus, Providencian heimbachae, Rhodococcus rhodnii, Sphingomonas terrae, Corynebacterium spp., Sphingomonas sanguinis, Staphylococcus aureus, MRSA, Staphylococcus hominis hominis, Stenotrophomonas maltophlia, Xanthomonas spp.

11. Antimicrobial textiles such as those mentioned in claim 1 which are characterized by anticandidal properties against Candida albicans, Candida glabrata, Candida parapsilosis, Candida tropicalis, Filobasidiella neoformansve, Hyphopichia burtanii, Kluyveromyces marxianus, Pichia membranifaciens, Schwanniomyces occidentalis.

12. Antimicrobial textiles such as those mentioned in claim 1 which are characterized by antifungal effect against Aspergillus spp., Alternaria spp., Botrytis spp., Fusarium spp., Paecilomyces lilacinus, Penicillium charlesii, Penicillium expansum, Penicillium vinaceum, Pythium spp., Phytophthora spp., Sclerotinia sclerotiorum.

13. Antimicrobial textiles such as those mentioned in claim 1 which can be used for dialysis filters, band-aids, surgery clothing, masks, scrub hats and caps, catguts and surgical cloth in the medical sector, for clothing industry, for work clothes, for fusing and interlining, for underwear, for babies' garments requiring hygiene, for carpets, curtains, floor tiles, table clothes, bed covers and all other textile raw materials and ancillary products requiring hygiene.
